(19) United States
(12) Patent Application Publication
(10) Pub. No.: US 2008/0239338 A1
(43) Pub. Date: Oct. 2, 2008

(54) Method For Performing Error Diffusion Halftoning of an Image

(76) Inventors: James Ray Bailey, Georgetown, KY (US); Christopher Wilson Case, Georgetown, KY (US); David Allen Crutchfield, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/691,524

(22) Filed: Mar. 27, 2007

(51) Int. Cl. H04N 1/60

(52) U.S. Cl. 358/1.9; 358/3.06

(57) ABSTRACT

A method for performing error diffusion halftoning of an image includes subdividing the image into a plurality of tiles, the plurality of tiles including a first tile and a second tile adjacent to the first tile; performing error diffusion processing of the first tile; and performing the error diffusion processing of the second tile based on an output phase of the first tile.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to imaging, and, more particularly, to a method for performing error diffusion halftoning of an image.

2. Description of the Related Art

Printers have been developed for home and business use, and are often used to reproduce continuous tone images displayed on other devices, such as computer monitors. The continuous tone images may include scanned images, photos downloaded from the internet or from a digital camera, as well as images created or modified by a user with various application software products that are available to businesses and consumers alike. The images are referred to as continuous tone images, or contone images, because the output value for each pixel may vary in an allowable range of intensity, for example, from 0-255 for 8-bit color. On the other hand, with a printer, for example, the output is discrete. That is, for a printer, a given pixel is either printed or not printed, with no variation in between. In order to reproduce continuous tone images on a printer, a process of halftoning must be performed on the image data before the image may be printed. Various halftoning methods are available, including dithering, masking, and error diffusion. These methods are used in digital printing to convert the multi-level i.e., gray level, input values from the continuous tone image to bi-level output values to be printed.

With the error diffusion method of halftoning, each input value associated with a pixel location in an image is compared with a threshold. If the input value along with any accumulated error is greater than the threshold, the pixel is turned on, i.e., printed, and an error, which is the difference between the input value and the maximum-input value of 255 (for 8-bit color), is spread over to certain neighbors of the pixel, contributing to the accumulated error of those pixel neighbors. If the input is smaller than the threshold, the pixel is not turned on, and the input value plus any accumulated error is spread over to certain neighbors of the pixel as error, contributing to the accumulated error of those pixel neighbors.

Error diffusion halftoning is computationally intensive, particularly where large, high resolution images are involved. Although multi-processor computers and printers are increasingly available in the home and business markets, prior art error diffusion methods do not efficiently employ the multiple processors of such machines to perform parallel processing, resulting in error diffusion processing that takes longer than otherwise necessary.

What is needed in the art is an improved method for performing error diffusion halftoning.

### SUMMARY OF THE INVENTION

The present invention provides a method for performing error diffusion halftoning of an image.

The present invention, in one form thereof, relates to a method for performing error diffusion halftoning of an image. The method includes subdividing the image into a plurality of tiles, the plurality of tiles including a first tile and a second tile adjacent to the first tile; performing error diffusion processing of the first tile; and performing the error diffusion processing of the second tile based on an output phase of the first tile.

The present invention, in another form thereof, relates to a method for performing error diffusion halftoning of an image. The method includes subdividing the image into a plurality of tiles, the plurality of tiles including a first tile and a second tile adjacent to the first tile; defining an overlap region at a boundary of the first tile and the second tile; and performing error diffusion processing of the first tile using the first tile and the overlap region.

The present invention, in still another form thereof, relates to a method for performing error diffusion halftoning of an image, wherein the image is formed of a plurality of raster lines. The method includes subdividing the image into a plurality of tiles, the plurality of tiles including a first tile and a second tile adjacent to the first tile, wherein at least a subset of at least one raster line of the plurality of raster lines extends through both the first tile and the second tile; performing error diffusion processing of the first tile for each raster line of the subset of raster lines; storing at least one error value based on the error diffusion processing of the first tile; retrieving the at least one error value; and performing the error diffusion processing of the second tile based at least in part on the at least one error value

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 depicts an imaging system used in accordance with an embodiment of the present invention;

FIG. 2 is a diagrammatic depiction of a halftone functional unit employed in accordance with the embodiment of FIG. 1;

FIG. 3 depicts the spreading of error during Floyd-Steinberg based error diffusion;

FIG. 4 depicts that during error diffusion processing, images may be processed in a serpentine fashion from raster line to raster line;

FIG. 5A depicts an image that was conventionally halftone processed using a Floyd-Steinberg based error diffusion algorithm;

FIG. 5B depicts an image that was processed in tiles, where each tile is conventionally processed like a separate image and then stitched together upon completion, respectively;

FIG. 6 is a flowchart depicting a method for performing error diffusion halftoning of an image in accordance with an embodiment of the present invention;

FIG. 7 depicts an exemplary image employed in describing the method of FIG. 6;

FIG. 8 is a flowchart depicting error diffusion processing of a first tile in accordance with the embodiment of FIG. 6;

FIG. 9 depicts error values from error diffusion processing of a first tile being stored in a vertical error buffer for use in error diffusion processing of a second tile;

FIGS. 10A and 10B depict a first tile with an overlap region (FIG. 10A), and a second tile (FIG. 10B), with the overlap region being defined at a boundary of the first tile and the second tile, in accordance with an embodiment of the present invention;

FIG. 11 is a flowchart depicting error diffusion processing of a second tile in accordance with the embodiment of FIG. 6;

FIGS. 12A-12C depict a first tile (FIG. 12A), a second tile (FIG. 12B), and the first and second tiles stitched together (FIG. 12C);

FIG. 13 depicts threshold modification data in the form of a nudge curve in accordance with an embodiment of the present invention;

FIG. 14 depicts error values from error diffusion processing of a first tile and a second tile being stored in a horizontal error buffer for use in error diffusion processing of a third tile and a fourth tile;

FIG. 15 is a flowchart depicting error diffusion processing for remaining tiles in accordance with the embodiment of FIG. 6; and

FIG. 16 depicts an image subdivided into tiles for processing in time slices.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

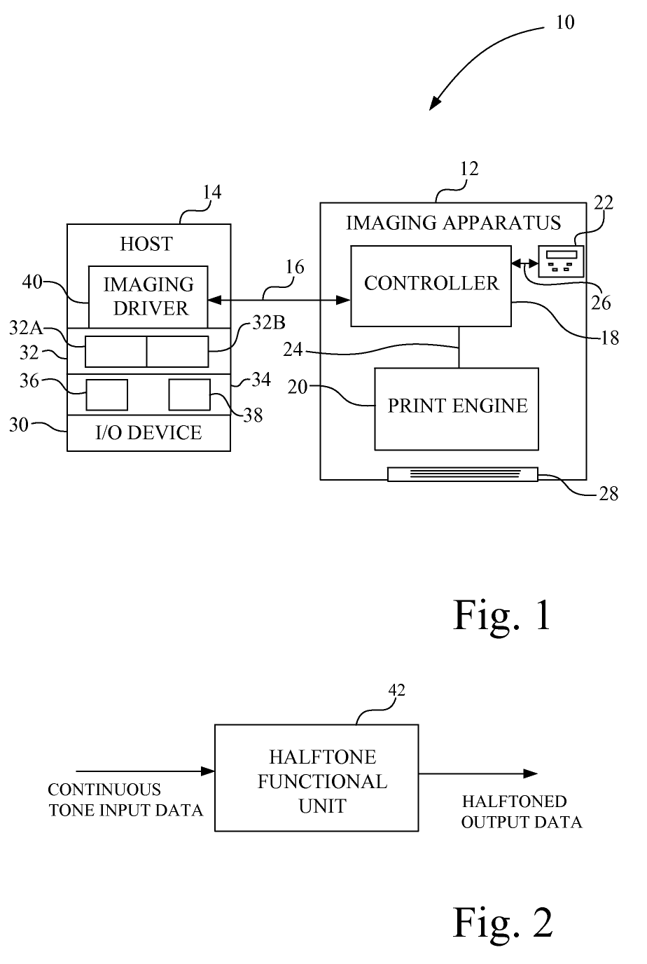

Referring now to the drawings, and particularly to FIG. 1, there is shown a diagrammatic depiction of a system 10 embodying the present invention. System 10 includes an imaging apparatus 12 and a host 14. Imaging apparatus 12 communicates with host 14 via a communications link 16.

Imaging apparatus 12 is an imaging device that produces a printed or scanned output of a patent or latent image. As used herein, an image is a rendering such as may be obtained via a digital camera or scanner, or which may be created or manipulated on a computer, such as host 14, and which may be printed or displayed for viewing by the human eye. Imaging apparatus 12 may be, for example, an ink jet printer and/or copier, or an electrophotographic (EP) printer and/or copier. Imaging apparatus 12 includes a controller 18, a print engine 20 and a user interface 22. In other embodiments of the present invention, imaging apparatus 12 may alternatively be a display, such as a computer monitor, wherein it may be desired to reduce the resolution of an original image for display purposes.

In the context of the examples for imaging apparatus 12 given above, print engine 20 can be, for example, an ink jet print engine or an EP print engine, configured for forming a patent image on a print medium 28, such as a sheet of paper, transparency, or fabric, from a latent image.

Controller 18 includes a processor unit and associated memory, and may be formed as an Application Specific Integrated Circuit (ASIC). In other embodiments, processor unit of controller 18 may include a multiprocessor core having two or more microprocessor units. Controller 18 communicates with print engine 20 via a communications link 24. Controller 18 communicates with user interface 22 via a communications link 26.

Host 14 may be, for example, a personal computer including an input/output (I/O) device 30, such as keyboard and display monitor. Host 14 further includes a multiprocessor core 32 including more than one processing unit, such as two microprocessor units 32A and 32B, input/output (I/O) interfaces, memory 34, such as RAM, ROM, and/or NVRAM, including a vertical error buffer 36 and a horizontal error buffer 38, and a mass data storage device, such as a hard drive, CD-ROM and/or DVD units. During operation, host 14 includes in its memory a software program including program instructions that function as an imaging driver 40, e.g., printer driver software, for imaging apparatus 12. Imaging driver 40 is in communication with controller 18 of imaging apparatus 12 via communications link 16. Imaging driver 40 facilitates communication between imaging apparatus 12 and host 14, and may provide formatted print data to imaging apparatus 12, and more particularly, to print engine 20. Alternatively, however, all or a portion of imaging driver 40 may be located in controller 18 of imaging apparatus 12.

Communications link 16 may be established by a direct cable connection, wireless connection or by a network connection such as for example an Ethernet local area network (LAN). Communications links 24 and 26 may be established, for example, by using standard electrical cabling or bus structures, or by wireless connection.

Referring now to FIG. 2, there is shown a halftone functional unit 42. Halftone functional unit 42 may be in the form of firmware or software, and in the present embodiment, is considered as part of imaging driver 40. In another embodiment, halftone functional unit 42 may formed as part of a controller, such as controller 18, having a multiprocessor core. Alternatively, it is considered that some portions of halftone functional unit 42 may reside in imaging driver 40 and other portions may reside in controller 18. In any case, halftone functional unit 42 performs error diffusion halftoning of an image to be printed, including accessing a weight set and a threshold when performing halftoning as described below. As used herein, a weight set, also known as a spread ratio, defines the proportion of error that will be spread, i.e., diffused, to neighboring pixels.

A continuous tone image, i.e., an image having continuous tone data, such as, for example, data in a gray value range of 0-255 for 8-bit color representation, is received by halftone functional unit 42. Halftone functional unit 42 processes the continuous tone data using computer executable steps to convert the continuous tone data into binary data for printing by print engine 20. In performing halftoning, halftone functional unit 42 utilizes multiple weight error diffusion. Halftone functional unit 42 is automatically initiated when continuous tone image data is supplied thereto.

In performing error diffusion, the intensity value, i.e., gray values of pixels of the original continuous tone image, are used as input values, and are processed in order to determine output values for each corresponding output pixel in the output image. In the present embodiment, the input values have a dynamic range of, for example, 0 to 255. Output values provided by halftone functional unit 42 are binarized output values of 0 or 1. A pixel having an output value of 0 will not be turned on, i.e., no pixel will be printed at the respective location on print medium 28, whereas a pixel having a binary output value of 1 will be printed by print engine 20 at the respective location on print medium 28.

In other words, when printing an image using an output device, such as imaging apparatus 12, that places discrete units of colorants (ink drops, toner, etc.) on print medium 28, the range of the image data should be reduced to match the reproduction capabilities of the device. That is, to reduce the bit resolution of the image. This is done by a halftone transformation. One common halftone transformation is known as error diffusion. Error diffusion works by spreading the inaccuracy, i.e., error, of the halftone decision at one pixel position in the output image among adjacent or near pixel positions, creating a visually pleasing transformation.

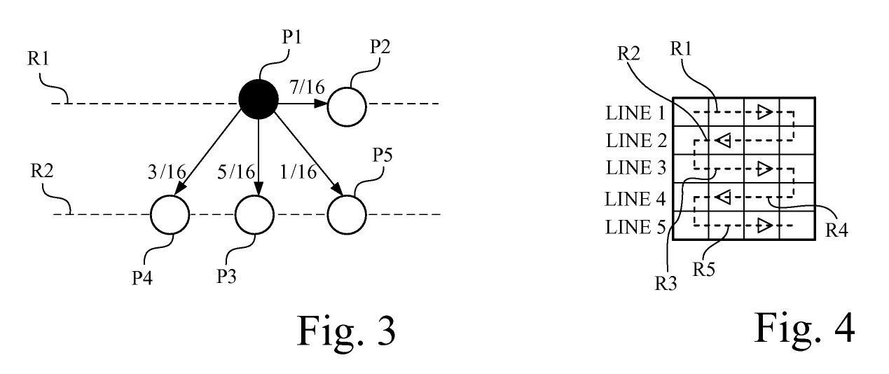

Referring now to FIG. 3, the most prominent error diffusion technique is referred to as Floyd-Steinberg error diffusion. Using this technique, 7/16 of the calculated error is spread from the current pixel P1 to the adjacent right pixel P2 on the same raster line R1 in the processing direction, which may be referred to as forward error, 5/16 to the adjacent lower pixel P3 in the subsequent raster line R2, 3/16 to the lower left pixel P4 in the subsequent raster line R2, which may be referred to as down-back error, and 1/16 to the lower right pixel P5 in the subsequent raster line R2 as shown in FIG. 3, yielding a weight set of ( 7/16, 5/16, 3/16, 1/16). Various implementations of Floyd-Steinberg error diffusion may diffuse error to some or all of the pixel locations (P2-P5) illustrated in FIG. 3, or may diffuse error to more pixel locations than those illustrated in FIG. 3.

Referring now to FIG. 4, in order to improve the output quality of the diffusion using a Floyd-Steinberg based error diffusion, images are processed in a serpentine fashion S from raster line to raster line in order to process all raster lines, e.g., R1-R5.

Because error values are spread to the next pixel, using conventional Floyd-Steinberg methodology, processing of the next pixel cannot begin until processing of the current pixel is complete. In addition, because error values are also spread to the next line and each line is processed in the opposite direction of the previous line, using conventional Floyd-Steinberg methodology, processing of the next line cannot begin until processing of the current line is complete. Thus, Floyd-Steinberg based error diffusion techniques are not appropriate for working on different sections of the same image, independently and in parallel.

In multi-processor computing systems, such as host 14, it may be desirable to error diffuse the image in tiles, where multiple tiles may be processed in parallel by multiple processors in order to optimize error diffusion performance. However, simply performing error diffusion on the image in independent tiles and stitching the tiles together to form the output image results in severe artifacts at the tile boundaries.

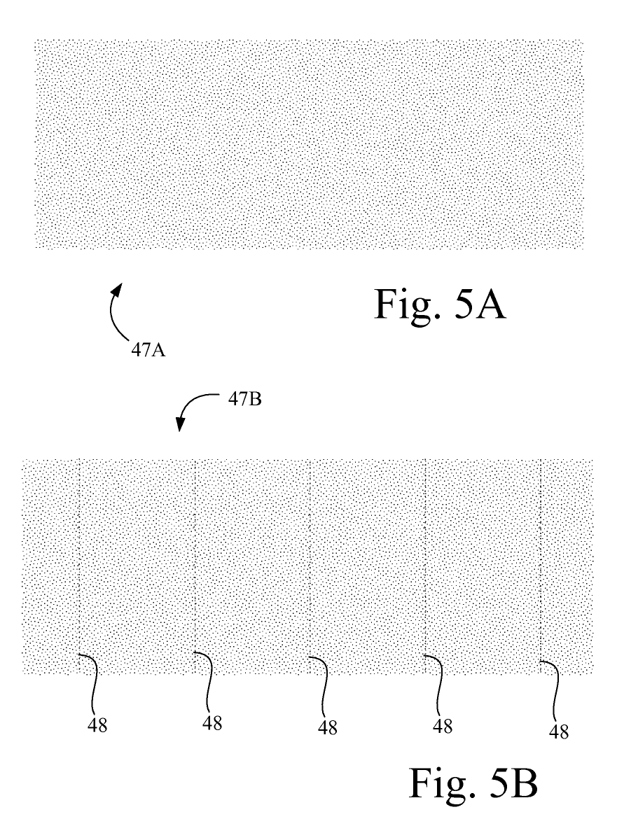

For example, referring now to FIGS. 5A and 5B, images 47A and 47B are depicted, each of which was halftoned using a Floyd-Steinberg based error diffusion algorithm. The image 47A of FIG. 5A was processed conventionally, wherein the entire image was processed from start to finish. The image 47B of FIG. 5B was processed in tiles, where each tile was processed as a separate image and then stitched together upon completion. As seen in FIG. 5B, the image exhibits stitching artifacts 48 where each tile was joined to another tile. Such artifacts are unacceptable for imaging devices such as ink jet and laser printers.

By subdividing the image into tiles, the time required to halftone the image may be reduced by employing each processor of a multi-processor core to perform error diffusion on a different tile. However, by doing so using conventional Floyd-Steinberg based error diffusion, artifacts are generated at the boundaries where the tiles are stitched, i.e., aligned, together.

The present invention provides a method for performing error diffusion of an image on a tile-by-tile basis that may reduce or eliminate the visible stitching artifacts, yielding an image that may appear visually equivalent to an image that was halftoned using conventional Floyd-Steinberg based error diffusion. However, because the error diffusion is performed tile-by-tile, the halftoning process time may be reduced by performing parallel processing of tiles using the multiple processors of a multiprocessor core.

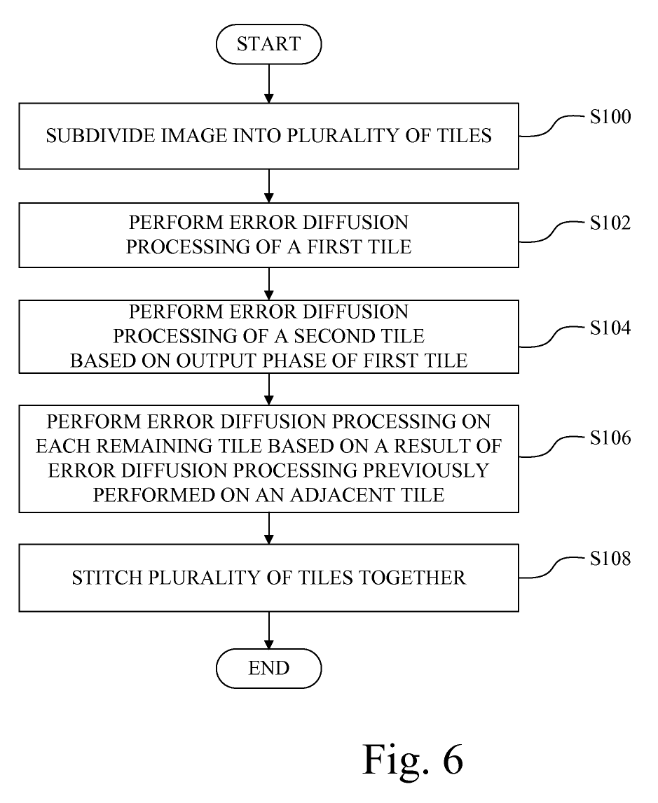

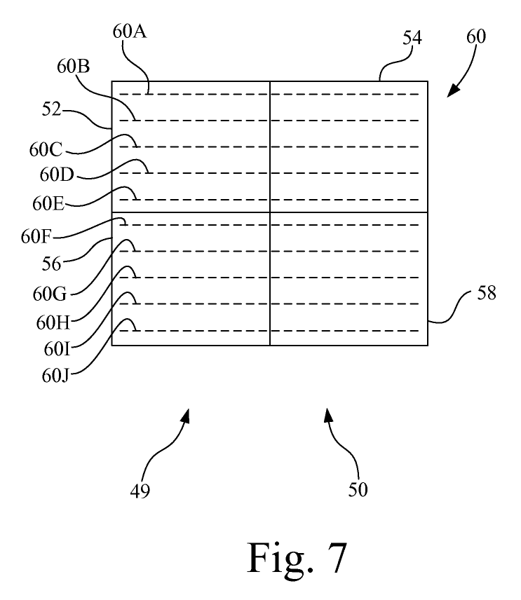

Referring now to FIG. 6 and steps S100-S108, a method for performing error diffusion halftoning of an image in accordance with an embodiment of the present invention is generally depicted. In the present embodiment, steps S100-S108 are performed by imaging driver 40 in conjunction with microprocessor unit 32A, microprocessor unit 32B, and controller 18. Steps S100-S108 are described with respect to an exemplary image 49, depicted in FIG. 7.

At step S100, image 49 is subdivided into a plurality of tiles 50, plurality of tiles 50 including a tile 52, a tile 54 adjacent to tile 52, a tile 56 adjacent to tile 52 and adjacent to tile 54, and a tile 58 adjacent to tiles 52, 54, and 56. In the present embodiment, each tile is depicted as being the same shape and size. However, it will be understood that tiles of different shapes and sizes may be employed without departing from the scope of the present invention. Nonetheless, image 49 is formed of a plurality of raster lines 60, at least a subset, e.g., raster lines 60A-60E, comprised of at least one raster line of the plurality raster lines of which extend through both tile 52 and tile 54. Raster lines 60F-60J extend through both tile 56 and tile 58.

In the present description, reference is made to a first tile, and a second tile. Although such references may be used herein to describe tiles 52 and 54, respectively, it will be understood that the terms “first tile” and “second tile” pertain to a general order of processing as between two adjacent tiles in accordance with embodiments of the present invention, as will be made apparent by the following description.

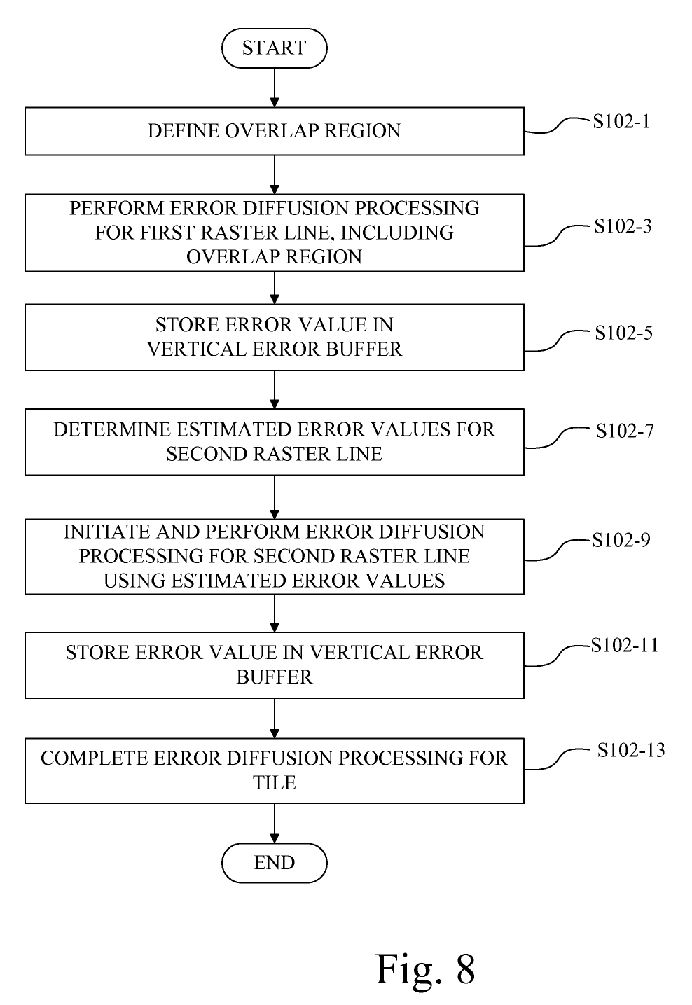

At step S102, error diffusion processing of a first tile, such as tile 52, is performed. Step S102 is explained in greater detail below with respect to FIG. 8 and steps S102-1 to S102-13.

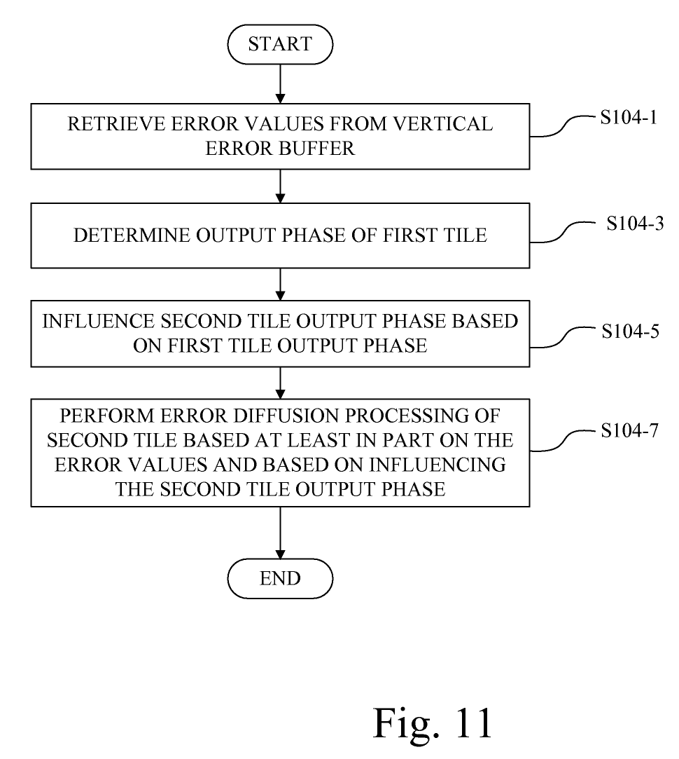

At step S104, error diffusion processing of a second tile, such as tile 54, is performed based on an output phase of the first tile, e.g., tile 52. The output phase is a phase of the dots that will be printed based on the error diffusion, e.g., the phase of the dots on each raster line. Step S104 is explained in greater detail below with respect to FIG. 11 and steps S104-1 to S104-7. In summary, however, the error diffusion of the second tile is performed so that the output phase of the second tile corresponds to the output phase of the first tile, so as to reduce or eliminate stitching artifacts at the boundary where the first tile and second tile are aligned to form that portion of the halftoned image 49.

At step S106, error diffusion processing of each remaining tile of plurality of tiles 50, e.g., tile 56 and tile 58, is performed based on the results of error diffusion processing previously performed on at least one adjacent tile of plurality of tiles 50, which will be made apparent in the below detailed discussion of steps S102 and S104. For example, error diffusion processing for tile 56 is performed based on the results of the error diffusion processing of tile 52 and tile 54, and the error diffusion processing of tile 58 is performed based at least on the results of the error diffusion processing of tile 54 and tile 56. On the other hand, if image 49 had another tile beside tile 54, the error diffusion processing of such a tile would be performed based on the results of the error diffusion processing of tile 54.

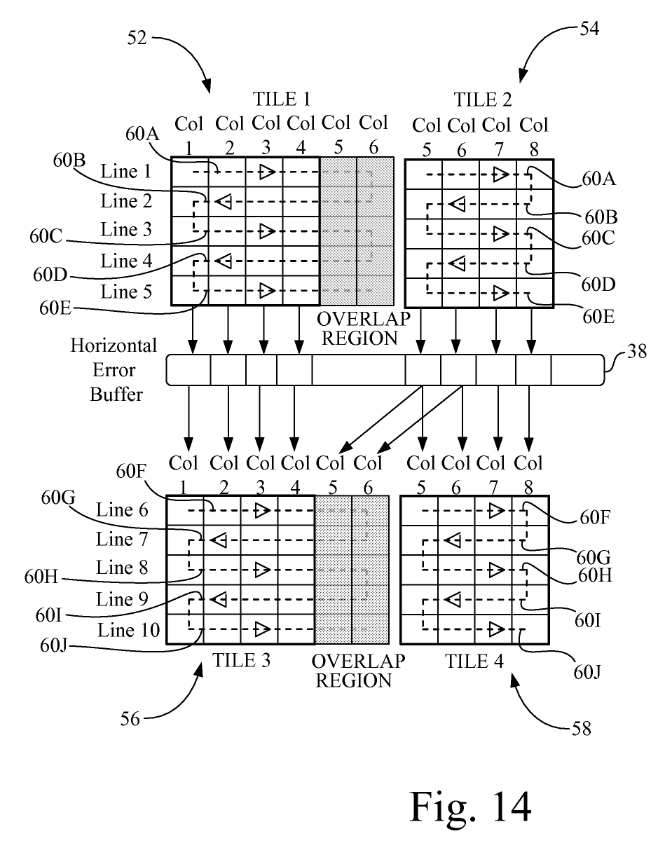

In addition to performing error diffusion processing of each tile based on the error diffusion processing previously performed on a horizontally adjacent tile, the error diffusion processing for each tile is based on the previously performed error diffusion processing for a vertically adjacent tile, which is described in greater detail below with respect to FIG. 14 steps S106-1 to S106-7.

In the present embodiment, error diffusion halftoning is performed using a microprocessor unit 32A and microprocessor unit 32B, wherein at least one tile is processed using microprocessor unit 32A in parallel to at least another tile being processed using microprocessor unit 32B. However, it will be understood that any number of processors may be employed for parallel error diffusion processing in accordance with embodiments of the present invention.

At step S108, plurality of tiles 50 are stitched together, i.e., aligned together, thus re-forming image 49 as a halftoned image.

Referring now to FIG. 8, step S102 is described in greater detail with respect to steps S102-1 to S102-13.

At step S102-1, an overlap region is defined at a boundary of the first tile and the second tile.

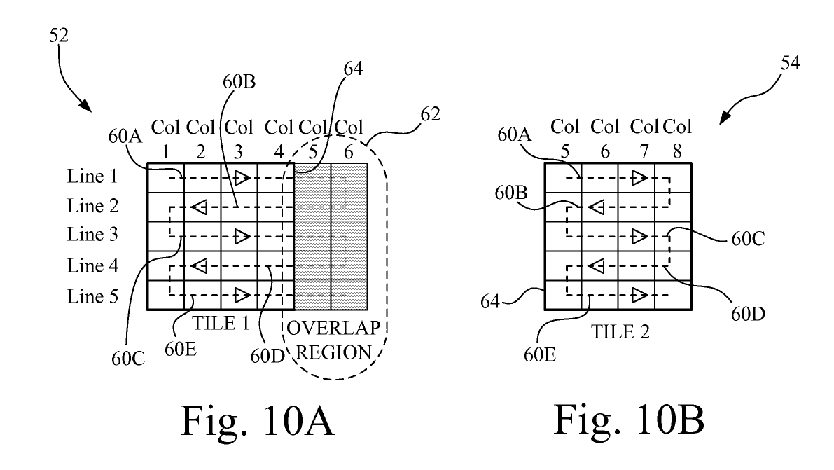

For example, referring now to FIGS. 10A and 10B, an overlap region 62 is defined at a boundary 64 between tile 52 and tile 54. As depicted, tile 52 includes 4 columns (Col1 through Col4), and five (5) raster lines 60A-60E (lines 1-5). Overlap region 62 in the present example is columns 5 and 6 (Col5 and Col6) and raster lines 60A-60E, which is a part of tile 54. For example, FIG. 10B depicts tile 54, which itself includes columns 5 and 6, as well as columns 7 and 8 (Col7, Col8) and raster lines 60A-60E.

At step S102-3, error diffusion processing of the first raster line 60A in tile 52, including overlap region 62, is performed.

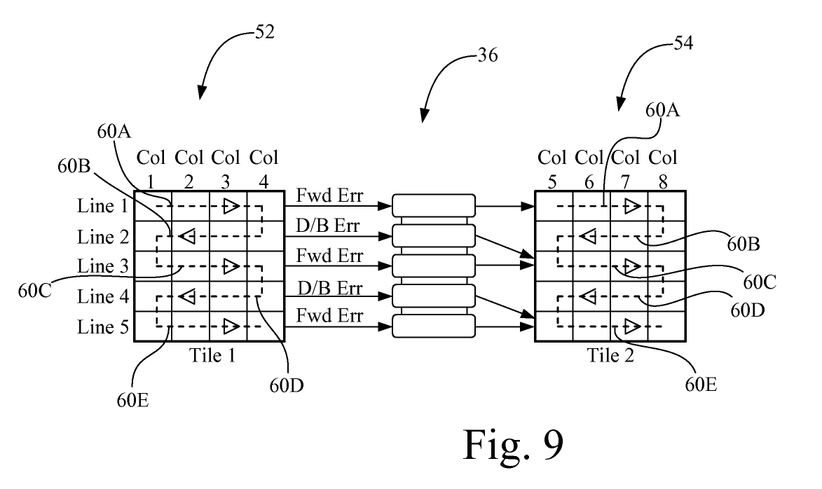

At step S102-5, a first error value from raster line 60A in tile 52 is stored in vertical error buffer 36 (see FIG. 9) while performing error diffusion processing of tile 52, the first error value being designated for diffusion along raster line 60A.

For example, raster line 60A is processed from left-to-right. If the forward error spread value (e.g., corresponding generally to the 7/16 value shown in FIG. 3) calculated for the last location in the first raster line of tile 52 could be used in the calculation of the starting running error (i.e., the sum of all errors to this location plus the source value of the pixel) for the first line of tile 54, then the output of the first line (raster line 60A) for both tiles would appear the same as the output of an image that is not tiled.

Accordingly, at step S102-5, the forward error value at the end of the forward going raster line in tile 52 is stored to a memory and read in by the adjacent tile to accurately compute its first running error value. Additionally, the down-back error (e.g., corresponding generally to the 3/16 value shown in FIG. 3) will be stored from the pixel at boundary 64 in the reverse going lines of tile 52 (in step S102-11, below) and used in the starting running error calculation for tile 54.

Referring now to FIG. 9, the collective memory in which the forward error values and down-back error values are stored is vertical error buffer 36, (in FIG. 9, D/B Err refers to the down-back error value; Fwd Err refers to the forward error). In the event that the error to be diffused is zero, stored error values, e.g., forward and down-back error values, will also be zero. In the present embodiment, the forward error values and down-back error values are stored in discrete locations in vertical error buffer 36. Alternatively, in another embodiment, it is contemplated that for some pairs of raster lines, a forward error value may be combined with a down-back error value into a single value and then stored in vertical error buffer 36, thereby allowing the size of vertical error buffer 36 to be reduced, and also thereby allowing the frequency of access to vertical error buffer 36 to be reduced. For example, in such an embodiment, the down-back error value from raster line 60B and the forward error value from raster line 60C in FIG. 9 may be combined into a single value and stored in vertical error buffer 36. Similarly, the down-back error value from raster line 60D and the forward error value from raster line 60E in FIG. 9 may be combined into a single value and stored in vertical error buffer 36.

After raster line 60A in tile 52 is processed and its forward error value is stored into vertical error buffer 36, the second line in tile 52, raster line 60B, is then processed in reverse from right to left. However, tile 54 has not been processed yet, and thus, the forward spread from the previous pixel for the start of line 2 (raster line 60B) in tile 52 is unknown. Therefore, the first running error calculation for the second line will be incorrect, unless other measures are taken. The start of every reverse going line is missing both the previous forward error and the previous down-back error. This inaccuracy is the source of artifacts in tiled error diffusion, which is addressed, at least in part, by step S102-7.

Referring again to FIG. 8, at step S102-7, estimated error values for raster line 60B in tile 52, which is subsequent in an order of processing to raster line 60A, are determined based on overlap region 62. In the present embodiment, the estimated error values include an estimated previous forward error and an estimated previous down-back error. The previous forward error pertains to the error that would be diffused in the direction of processing to a pixel on a raster line from the previously processed pixel on that raster line, which in the present example would be the error that would be diffused to the pixel at column 4 on raster line 60B from the pixel at column 5 on raster line 60B. The down-back error pertains to the error that would be diffused to a pixel on a raster line processed subsequent to the current pixel's raster line, and in a direction opposite to the raster line processing direction, which in the present example would be the error that would be diffused to the pixel at column 4 of raster line 60B from the pixel at column 5 of raster line 60A.

In the present embodiment, the estimated error values are determined by performing error diffusion processing on overlap region 62, which may be explained as follows.

If the previous forward error and previous down-back error were known for the start of the reverse going lines, then the tiled error diffusion system would be similar in its output to a traditional error diffusion system. The term, “previous” in this context is used to indicate that the previous forward and previous down-back errors pertain to the errors to be diffused from previously processed pixel positions, as opposed to error to be diffused from the current pixel position being processed. These values must be approximated by some means. The closer the approximated values are to the actual values, the closer the tiled error diffusion output in accordance with the present invention will be to the traditional system. Accordingly, with the present invention, the previous forward error and previous down-back error for reverse lines are approximated by processing a region of overlap (overlap region 62) in the horizontally adjacent tile. When processing the overlap region for a given tile, there is no error diffused output for that region. This region is simply used to allow error diffusion to run and calculate the running errors for those overlap pixels in order to better approximate the previous forward and down-back errors for reverse going lines. FIGS. 10A and 10B illustrate how the tiled system of FIG. 9 changes to accommodate this aspect of the invention.

In FIG. 10A, two columns of tile 54 are processed as the overlap region 62 in tile 52. By processing these extra two columns, the previous forward and down-back errors are approximated for the start of the reverse going lines. The forward error from forward going lines and the down-back error from reverse going lines are stored for use in performing error diffusion processing for tile 54, which starts at boundary 64 as in FIG. 10A. Thus, overlap region 62 is processed twice in accordance with an embodiment of the present invention, once for reverse line error approximation for tile 52, and once to generate error diffused output for tile 54.

If overlap region 62 for tile 52 was as wide as the rest of the image, then the approximated starting forward and down-back errors for reverse lines would be exact, and there would be no difference in the output of the tiled error diffusion system of the present invention and traditional error diffusion (if a vertical error buffer is used between tiles). Obviously, processing the rest of the image as the overlap defeats a purpose of tiled error diffusion, that being to allow parallel processing of the image using multiple processors, such as microprocessor unit 32A and microprocessor unit 32B. However, the wider the overlap region is, the more accurate the approximation of the forward and down-back errors will be, and fewer stitching artifacts will be visible.

At step S102-9, error diffusion processing for raster line 60B is initiated and performed in tile 52 using the estimated error values.

At step S102-11, an error value from the reverse going raster line 60B is stored in vertical error buffer 36 while performing error diffusion processing of tile 52. This error value is a down-back error value designated for diffusion on raster line 60C, as illustrated in FIG. 9, wherein raster line 60B is subsequent in an order of processing to raster line 60A, and raster line 60C is subsequent in an order of processing to raster line 60B.

At step S102-13, error diffusion processing is performed and completed for tile 52, using both tile 52 and overlap region 62, for example, by repeating steps S102-3 to S102-11 until all raster lines have been processed.

Thus, with steps S102-1 to S102-13, error diffusion processing for each raster line of tile 52 is performed, and in addition, error values based on the error diffusion processing of tile 52 are stored in vertical error buffer 36 for use performing error diffusion processing on tile 54.

Referring now to FIG. 11, step S104 is described in greater detail with respect to steps S104-1 to S104-7.

At step S104-1, the error values stored in vertical error buffer 36 are retrieved for use in performing error diffusion processing on tile 54.

By performing error diffusion processing of a second tile based on the error values stored in vertical error buffer 36 from the processing of a first tile, the phase of the output pattern (output phase) of the second tile will be in greater agreement as with respect to the first tile than had the stored error values not be used in processing the second tile.

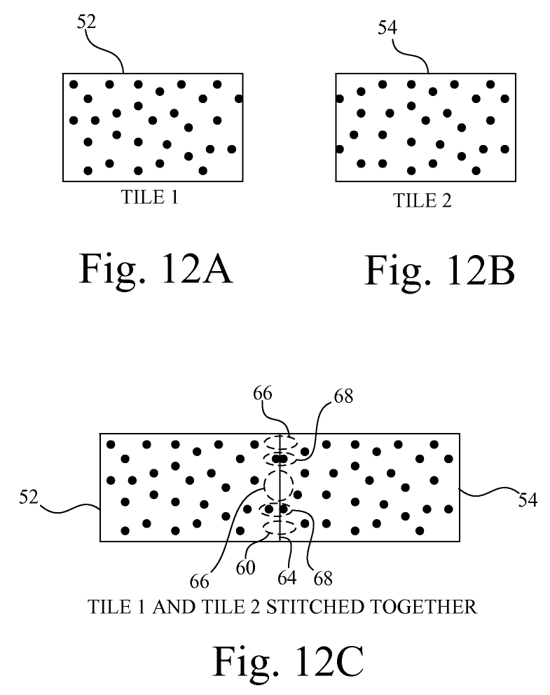

The use of vertical error buffer 36 and the processed overlap region 62 eliminate a substantial amount of stitching artifacts in tiled error diffusion. However, the system may still exhibit some stitching artifacts. This is due to the fact that although each tile is creating an output pattern of dots, often with the same frequency, the output pattern from each tile may not be entirely in phase with one another even after using the stored error for processing the second tile. Placing two out-of-phase output patterns beside one another will create dot holes 66 and dot pairs 68 at the boundary of the patterns, artifacts that are undesirable and unacceptable. This phenomenon is shown in FIGS. 12A-12C.

Referring now to FIGS. 12A-12C, tiles 1 and 2 (tile 52 and tile 54) are illustrated separately in FIGS. 12A and 12B, respectively, and are illustrated as being stitched (aligned) together in FIG. 12C. In FIG. 12C, it is apparent that dot holes 66 and dot pairs 68 are formed in the region of boundary 64 between tile 52 and tile 54. The amount of dot holes 66 and dot pairs 68 that are formed is substantially less than the amounts of each that would be formed had steps S102-1 to S102-13 not been performed. Nonetheless, even the reduced amount of dot holes 66 and dot pairs 68 yield artifacts that may be visibly apparent in the final image.

If the output patterns of tile 52 and tile 54 are in phase with one another at stitch boundary 64, artifacts resulting from dot holes 66 and dot pairs 68 may be eliminated. Thus, in order to place the output patterns in phase, the phase information for the first tile (e.g., tile 52) is captured. Then, this information is used to set the phase of the horizontally adjacent tile (e.g., tile 54). Using the overlap technique shown in FIG. 10A, the phase of the error diffused output from overlap region 62 may be captured when processing the first tile by simply storing the error diffused output values of overlap region 62 to a memory buffer, for example, in a portion of memory 34 of host 14. The phase information captured describes when and where dots were to be placed in the overlap region, both for forward and reverse going lines. This information is captured for both directions since any inaccuracy introduced by processing reverse going lines is spread to subsequent forward going lines, thus affecting those as well. Since the overlap region will be processed again by the horizontally adjacent tile, the output phase of this region can be set by utilizing the information captured from the previous tile.

For example, if a dot would have been placed at line 1 (e.g., raster line 60A), column five (Col5) in FIG. 10A when processing overlap region 62 for tile 52, then when column five is processed for tile 54, a dot should be placed for line 1, column five to further set the output pattern of tile 52 and tile 54 in phase with one another. One way to accomplish this is to force it to happen unconditionally. However, in practice, this may lead to other artifacts due to ill effects on all of the mechanics involved in error diffusion. A better approach, employed in accordance with the present embodiment, is to “influence” a dot placement at that location by lowering the threshold that the running error will be compared against. By lowering the threshold for this location, the likelihood is increased that a dot will be placed, since it is more likely that the running error will exceed the lowered threshold and place a dot. To influence no dot placement at a given location, that is, to influence against placing a dot, the threshold could be raised, making it less likely that the running error will exceed the threshold and allow a dot to be placed. Accordingly, in accordance with an embodiment of the present invention, a threshold modification curve is constructed from the error diffused output of the overlap region and applied to modify the threshold for those locations when processed by the horizontally adjacent tile. This curve may be referred to as a curve of influence or a “nudge curve”. Constructing and applying a linear curve of modification to the threshold values allows the influence to continue for a dot placement even if the exact point where a dot was placed in the overlap fails to produce a dot in the horizontally adjacent tile. In other words, even if at the exact point where a dot is being influenced to be placed still does not get placed, the influence will continue but lessen for the next location.

Accordingly, referring again to FIG. 11, at step S104-3, the output phase of the first tile, e.g., tile 52, is determined. In the present embodiment, the output phase is determined by capturing the error diffused output values of overlap region 62, and storing them in memory 34.

At step S104-5, the second tile (e.g., tile 54) output phase is influenced based on the first tile output phase.

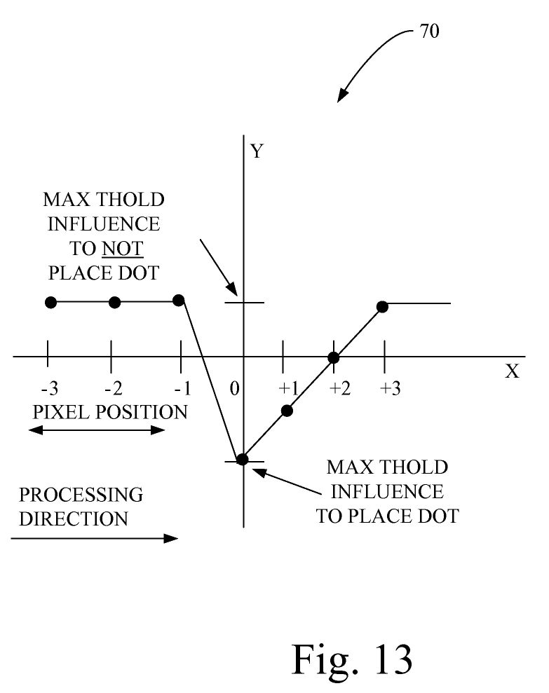

Referring now to FIG. 13, in the present embodiment, step S104-7 is performed by determining threshold modification data, illustrated in the form of an example nudge curve 70, which is applied to modify the error diffusion thresholds in the second tile adjacent to boundary 64, and to thus influence the output phase of the second tile. Nudge curve 70 is dynamically determined based on previous error diffusion output for the raster line being processed. In other embodiments, it is alternatively contemplated that nudge curve 70 may be static. The term, “nudge curve” relates to the fact that nudge curve 70 is used to “nudge” dot placement decisions of error diffusion processing of the second tile. As set forth above, by modifying the thresholds, the likelihood of dot placement at a pixel location may be increased or decreased, which is how the output phase of the second tile is influenced in the present embodiment. The X-axis of nudge curve 70 pertains to the pixel position along the processing direction, with the Y-axis being located at boundary 64. Thus, pixel positions −3, −2, and −1 depicted on nudge curve 70 are respectively the third, second, and first pixel positions in the first tile, e.g., tile 52, as measured from boundary 64, whereas pixel locations +1, +2, and +3 represent the first, second, and third pixel positions in the second tile, e.g., tile 54, beyond the pixel location at boundary 64. The Y-axis of nudge curve 70 pertains to the amount of threshold modification, with positive values (above the X-axis) representing an increase in the threshold, which reduces the likelihood that a dot will be printed for the corresponding pixel location, and the negative values (below the X-axis) representing a decrease in the threshold, which increases the likelihood that a dot will be printed for the corresponding pixel location. In the present embodiment, the threshold modification data is determined for each raster line of the plurality of raster lines that are in the second tile.

In the example of FIG. 13, at location 0, a dot is desired to be placed since it would have been placed according to the overlap output (processing of overlap region 62). In this example, no other dots are to be placed except at this position. At positions −3 to −1, the maximum threshold (THOLD) influence to not place a dot is asserted. At position 0, a maximum threshold (THOLD) influence to place a dot is asserted. At position +1, less influence is to place a dot is asserted. At position +2, even less influence to place a dot is asserted. At position +3, the maximum influence to not place a dot is asserted. A maximum amount of influence asserted (the Y-axis of FIG. 13) in the range of 25% to 50% of the actual threshold value for the pixel shade being processed yielded favorable results. In this implementation, the influence amount varied based on the source pixel value (i.e., the shade of the pixel under operation) since the threshold used varied based on the source value. In other embodiments, the influence amount may vary across the overlap region.

Once the output pattern is in phase with the previously processed overlap region, then nudge curve 70 can change to a phase locked nudge curve. A phase locked nudge curve will assert maximum influence at each position where dots are or are not to be placed without any gradual reduction in influence. The phase can be detected to be locked if n number of dots are placed at the exact same locations as stored by the processed overlap output. If a previous line was not detected to be phase locked, then the threshold amount may be increased dynamically. The end result would be that the output patterns between tiles are in phase with one another, eliminating stitching artifacts when combined with the other described techniques herein.

At step S104-7, error diffusion processing of tile 54 is performed. The error diffusion processing of tile 54 is performed similar to the error diffusion processing of tile 52, except that the error diffusion processing of tile 54 is based on the error values stored in vertical error buffer 36. For example, the error diffusion processing of tile 54 for raster lines 60A, 60C, and 60E is initiated based on the error values stored in vertical error buffer 36 from the error diffusion processing of tile 54. In addition, the error diffusion processing for the second tile is based on the influencing of the second tile output phase using the threshold modification data from step S104-5. The error diffusion processing of tile 54 includes performing the error diffusion processing on overlap region 62.

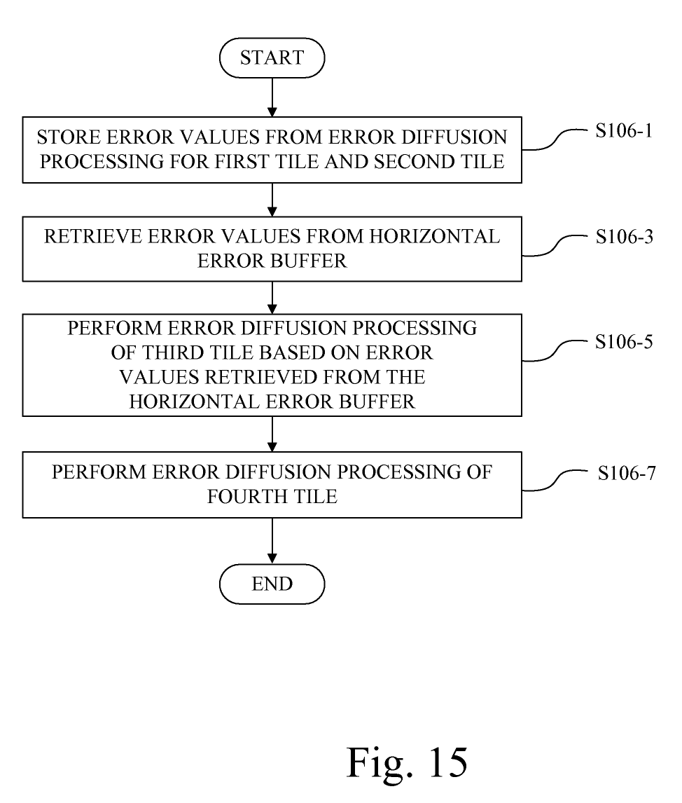

Referring now to FIGS. 14 and 15, step S106 is described in greater detail below.

Aspects of the present embodiment discussed in steps S102 and S104 pertain generally to techniques of performing error diffusion of horizontally adjacent tiles that may be stitched together without rendering visible artifacts. In order to effectively stitch together vertically adjacent tiles, the errors stored from processing the output pixels of previously processed vertically adjacent tiles are used in the calculation of the running errors for the current tiles.

Referring now to FIG. 14, tile 56 and tile 58 are depicted as being processed based on the previous error diffusion processing on vertically adjacent tiles 52 and 54, with error data from tile 52 and tile 54 being stored in horizontal error buffer 38 for use in processing tile 56 and tile 58. This is significant because the incoming previous errors used to calculate the running errors in the overlap for a third tile, e.g., tile 56, come from the actual dot placement computed in a second tile, e.g., tile 54. Error data from the first tile, e.g., tile 52, is supplied for error diffusion processing of tile 56. This aspect of the present invention helps eliminate stitching artifacts by keeping the output patterns in phase between vertically adjacent tiles.

The dependencies on data from adjacent tiles means there is an order of operations when performing error diffusion processing in accordance with the present invention. This is significant for multiprocessing systems, which may allow processing of tiles in parallel, e.g., with one processor performing error diffusion on one tile while another processor performs error diffusion processing on another tile. A tile cannot be processed until its previous horizontally adjacent tile (the tile to the left of the current tile) has been at least partially processed, as data from this tile will be stored in vertical error buffer 36 and used by the current tile. In the present embodiment, the error diffusion processing of the second tile is performed after completion of the error diffusion processing performed on the first tile. A tile also is not processed until its previous vertically adjacent tile (the tile directly above the current tile) has been processed, as data from this tile will be stored in horizontal error buffer 38 and used by the current tile. The tile above and to the right of the current tile should also have been processed, as data from this tile will also be stored in horizontal error buffer 38 and used in the current tile's overlap region, e.g., corresponding to overlap region 62.

Referring now to FIG. 15, step S106 is described in greater detail with respect to step S106-1 to S106-7.

At step S106-1, error values are stored in horizontal error buffer 38 from tile 52 and tile 54 during error diffusion processing of tile 52 and tile 54.

At step S106-3, the error values are retrieved from horizontal error buffer 38.

At step S106-5, error diffusion processing of the third tile, e.g., tile 56, is performed based on error values retrieved from horizontal error buffer 38, which includes the error diffusion processing of the third tile being performed based least in part on overlap region with tile 58 (see FIG. 14). The error diffusion processing of tile 56 is similar to that of tile 52, except that tile 56 receives incoming errors from horizontal error buffer 38, and is thus based on the output of error diffusion processing of tile 52 and tile 54.

At step S106-7, error diffusion processing of the fourth tile, e.g., tile 58, is performed based on error values retrieved from horizontal error buffer 38, and also based on the results of error diffusion processing of tile 56, for example, using the processed described above with respect to steps S102 and S104.

Although the present embodiment is described with respect to an image subdivided into four tiles, it will be apparent to those skilled in the art that the methodology described herein is fully applicable to an image subdivided into any number of tiles, wherein error diffusion processing for each subsequently processed tile is based on the error diffusion processing of at least one previously processed tile.

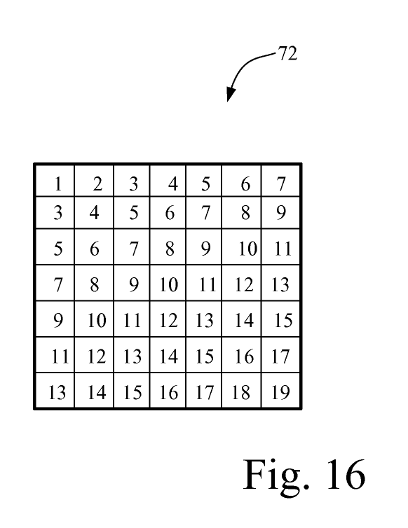

For example, referring now to FIG. 16, an image 72 is depicted as being broken up into 49 tiles, 7 horizontal tiles by 7 vertical tiles. Inside of each tile, a time slice number is given, which represents when this tile can be processed in relation to the other tiles. Notice that there are four tiles that can be processed in parallel during time slice 7. Given a system with 4 processors, this image comprising of 49 tiles can be processed in 19 time slices. Assuming there exists enough processors to process all possible parallel tiles for a given time slice, then the Number of time slices required to process an image=Number of tiles wide+2*(Number of tiles deep−1).

The present invention may allow an image to be error diffused in tiles with substantially no visible artifacts when stitching all of the tiles together to form the halftoned output image. Information is used from adjacent tiles to prevent stitching artifacts. The present invention may have significant implications for multiprocessing systems, as multiple processors may work in parallel to error diffuse an image, e.g., as set forth above with respect to FIG. 16. This is desirable due to the significant amount of processing time required to error diffuse images as well as the increasing presence of multiprocessor systems in end-user PCs. The present invention may also have implications in embedded imaging solutions as multiprocessor cores also have an increasing presence in this market. Today's printers (both laser and inkjet) have a growing requirement to output large numbers of pages per minute. Increasing error diffusion performance represents a major hurdle to achieving higher output rates. The present invention may address this issue by allowing high performance error diffusion systems to be created via multiprocessor cores. For example, in other embodiments, controller 18 may include a multiprocessor core configured to perform parallel error diffusion processing in accordance with the present invention. Further, it is possible that each tile could be comprised of a single raster line with the spread error values being placed into the respective vertical and horizontal error buffers.

The foregoing description of several methods and embodiments of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for performing error diffusion halftoning of an image, comprising:
subdividing said image into a plurality of tiles, said plurality of tiles including a first tile and a second tile adjacent to said first tile;
performing error diffusion processing of said first tile; and
performing said error diffusion processing of said second tile based on an output phase of said first tile.

2. The method of claim 1, further comprising performing said error diffusion processing of each remaining tile of said plurality of tiles based on the results of said error diffusion processing previously performed on at least one adjacent tile of said plurality of tiles.

3. The method of claim 2, further comprising stitching together said plurality of tiles.

4. The method of claim 1, wherein said image is formed of a plurality of raster lines, at least a subset comprised of at least one raster line of said plurality of raster lines extending through both said first tile and said second tile, further comprising:
storing a first error value from a first raster line of said subset of raster lines in said first tile while performing said error diffusion processing of said first tile, wherein said first error value is designated for diffusion along said first raster line; and
retrieving said first error value for use in said error diffusion processing of said second tile, wherein said error diffusion processing of said second tile for said first raster line in said second tile is performed based at least in part on said first error value.

5. The method of claim 4, wherein said first error value is stored in an error buffer.

6. The method of claim 4, further comprising:
storing a second error value from a second raster line of said subset of raster lines in said first tile while performing said error diffusion processing of said first tile, wherein said second error value is designated for diffusion on a third raster line of said subset of raster lines, said second raster line being subsequent in an order of processing to said first raster line, and said third raster line being subsequent in said order of processing to said second raster line; and
retrieving said second error value for use in said error diffusion processing of said second tile,
wherein said error diffusion processing of said second tile for said third raster line in said second tile is performed based at least in part on said second error value.

7. The method of claim 6, wherein said first error value and said second error value are stored in an error buffer.

8. The method of claim 1, wherein said image is formed of a plurality of raster lines, at least a subset comprised of at least one raster line of said plurality of raster lines extending through both said first tile and said second tile, wherein said error diffusion processing of said first tile includes:
performing said error diffusion processing of a first raster line of said subset of raster lines in said first tile; and
determining at least one estimated error value for a second raster line of said subset of raster lines in said first tile, said second raster line being subsequent in an order of processing to said first raster line.

9. The method of claim 8, wherein said error diffusion processing of said first tile further includes:
initiating said error diffusion processing of said second raster line in said first tile using said at least one estimated error value.

10. The method of claim 8, wherein said at least one estimated error value includes an estimated previous forward error and an estimated previous down-back error.

11. The method of claim 1, further comprising:
determining a first tile output phase; and
influencing a second tile output phase based on said first tile output phase,
wherein said performing said error diffusion processing of said second tile is based on said influencing said second tile output phase.

12. The method of claim 11, further comprising determining threshold modification data for said influencing said second tile output phase based on said first tile output phase, wherein said performing said error diffusion processing of said second tile is based on said threshold modification data.

13. The method of claim 12, wherein said image is formed of a plurality of raster lines, and wherein said threshold modification data is determined for each raster line of said plurality of raster lines that are in said second tile.

14. The method of claim 1, wherein said plurality of tiles includes a third tile adjacent to said first tile and adjacent to said second tile, further comprising:
storing error values from said error diffusion processing of said first tile and said error diffusion processing of said second tile;
retrieving said error values; and
performing said error diffusion processing of said third tile based on said error values.

15. The method of claim 1, wherein said error diffusion halftoning is performed using a first processor and a second processor, and wherein at least one tile of said plurality of tiles is processed using said first processor in parallel to at least another tile of said plurality of tiles being processed using said second processor.

16. A method for performing error diffusion halftoning of an image, comprising:
subdividing said image into a plurality of tiles, said plurality of tiles including a first tile and a second tile adjacent to said first tile;
defining an overlap region at a boundary of said first tile and said second tile; and
performing error diffusion processing of said first tile using said first tile and said overlap region.

17. The method of claim 16, wherein said error diffusion processing of said first tile includes determining at least one estimated error value for said first tile based on said overlap region.

18. The method of claim 17, wherein said at least one estimated error value includes an estimated previous forward error and an estimated previous down-back error.

19. The method of claim 16, further comprising performing said error diffusion processing of said second tile, including performing said error diffusion processing on said overlap region.

20. The method of claim 19, wherein said plurality of tiles includes a third tile adjacent to said first tile and adjacent to said second tile, further comprising performing said error diffusion processing of said third tile based least in part on said overlap region.

21. A method for performing error diffusion halftoning of an image, wherein said image is formed of a plurality of raster lines, comprising:
subdividing said image into a plurality of tiles, said plurality of tiles including a first tile and a second tile adjacent to said first tile, wherein at least a subset comprised of at least one raster line of said plurality of raster lines extends through both said first tile and said second tile;
performing error diffusion processing of said first tile for each raster line of said subset of raster lines;
storing at least one error value based on said error diffusion processing of said first tile;
retrieving said at least one error value; and
performing said error diffusion processing of said second tile based at least in part on said at least one error value.

22. The method of claim 21, wherein said at least one error value is stored in an error buffer.

23. The method of claim 21, wherein said at least one error value includes a forward error value and a down-back error value.

24. The method of claim 21, wherein said performing said error diffusion processing of said second tile is performed after completion of said performing said error diffusion processing of said first tile.
